(19) United States
(12) Patent Application Publication
(10) Pub. No.: US 2025/0392180 A1
(43) Pub. Date: Dec. 25, 2025

(54) COIL SUBSTRATE, MOTOR COIL SUBSTRATE, AND MOTOR

(71) Applicant: IBIDEN CO., LTD., Gifu (JP)

(72) Inventors: Takahisa HIRASAWA, Gifu (JP); Takayuki FURUNO, Gifu (JP)

(73) Assignee: IBIDEN CO., LTD., Gifu (JP)

(21) Appl. No.: 19/297,209

(22) Filed: Aug. 12, 2025

Related U.S. Application Data
(63) Continuation of application No. PCT/JP2024/004980, filed on Feb. 14, 2024.

(30) Foreign Application Priority Data
Feb. 16, 2023 (JP) 2023-022676

(51) Int. Cl. H02K 3/28; H01F 5/04; H01F 17/00

(52) U.S. Cl. CPC H02K 3/28; H01F 5/04; H01F 2017/006; H02K 2203/03

(57) ABSTRACT

A coil substrate includes a flexible substrate having a first surface and a second surface on the opposite side with respect to the first surface, a coil including a wiring and formed on the first surface and/or second surface of the flexible substrate, and a resin insulating layer covering the wiring of the coil formed on the first surface and/or second surface of the flexible substrate. The coil is formed such that the wiring has a first layer and a second layer covering an outer surface of the first layer and that the second layer has a first portion covering an upper surface of the first layer and a second portion covering a side surface of the first layer, and the wiring of the coil is formed such that the wiring has a width in a range of 60 μm to 400 μm and that a ratio T1/T2 of a thickness T1 of the first portion to a thickness T2 of the second portion satisfies 1.0<T1/T2≤1.4.

### CROSS-REFERENCE TO RELATED APPLICATIONS

The present application is a continuation of and claims the benefit of priority to International Application No. PCT/JP2024/004980, filed Feb. 14, 2024, which is based upon and claims the benefit of priority to Japanese Application No. 2023-022676, filed Feb. 16, 2023. The entire contents of these applications are incorporated herein by reference.

### BACKGROUND OF THE INVENTION

### Field of the Invention

The present invention relates to a coil substrate, a motor coil substrate formed using the coil substrate, and a motor formed using the motor coil substrate.

### Description of Background Art

Japanese Patent Application Laid-Open Publication No. S57-186941 describes a motor coil having a substrate and a coil conductor formed on the substrate. International Publication No. 2018/211733 describes a printed wiring board having a base film and a conductive pattern including multiple wiring parts formed on the base film. The entire contents of these publications are incorporated herein by reference.

### SUMMARY OF THE INVENTION

According to one aspect of the present invention, a coil substrate includes a flexible substrate having a first surface and a second surface on the opposite side with respect to the first surface, a coil including a wiring and formed on the first surface and/or second surface of the flexible substrate, and a resin insulating layer covering the wiring of the coil formed on the first surface and/or second surface of the flexible substrate. The coil is formed such that the wiring has a first layer and a second layer covering an outer surface of the first layer and that the second layer has a first portion covering an upper surface of the first layer and a second portion covering a side surface of the first layer, and the wiring of the coil is formed such that the wiring has a width in a range of 60 μm to 400 μm and that a ratio T1/T2 of a thickness T1 of the first portion to a thickness T2 of the second portion satisfies 1.0<T1/T2≤1.4.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a plan view schematically illustrating a coil substrate according to an embodiment of the present invention;

FIG. 2 is a cross-sectional view schematically illustrating a coil substrate according to an embodiment of the present invention;

FIG. 3A is a plan view schematically illustrating U-phase coils in a coil substrate according to an embodiment of the present invention;

FIG. 3B is a plan view schematically illustrating V-phase coils in a coil substrate according to an embodiment of the present invention;

FIG. 3C is a plan view schematically illustrating W-phase coils in a coil substrate according to an embodiment of the present invention;

FIG. 4 is a plan view comparing the U phase, V phase, and W phase of a coil substrate according to an embodiment of the present invention;

FIG. 5 is a plan view illustrating a simplified version of a coil substrate according to an embodiment of the present invention;

FIG. 6 is an enlarged cross-sectional view of a portion of FIG. 2;

FIG. 7 is a perspective view schematically illustrating a motor coil substrate according to an embodiment of the present invention;

FIG. 8 is an explanatory diagram schematically illustrating positions of terminals in a motor coil substrate according to an embodiment of the present invention;

FIG. 9 is a cross-sectional view schematically illustrating a motor according to an embodiment of the present invention;

FIG. 10 is a plan view schematically illustrating a coil substrate of a first modified example according to an embodiment of the present invention; and

FIG. 11 is a plan view illustrating a simplified version of the coil substrate of the first modified example.

### DETAILED DESCRIPTION OF THE EMBODIMENTS

Embodiments will now be described with reference to the accompanying drawings, wherein like reference numerals designate corresponding or identical elements throughout the various drawings.

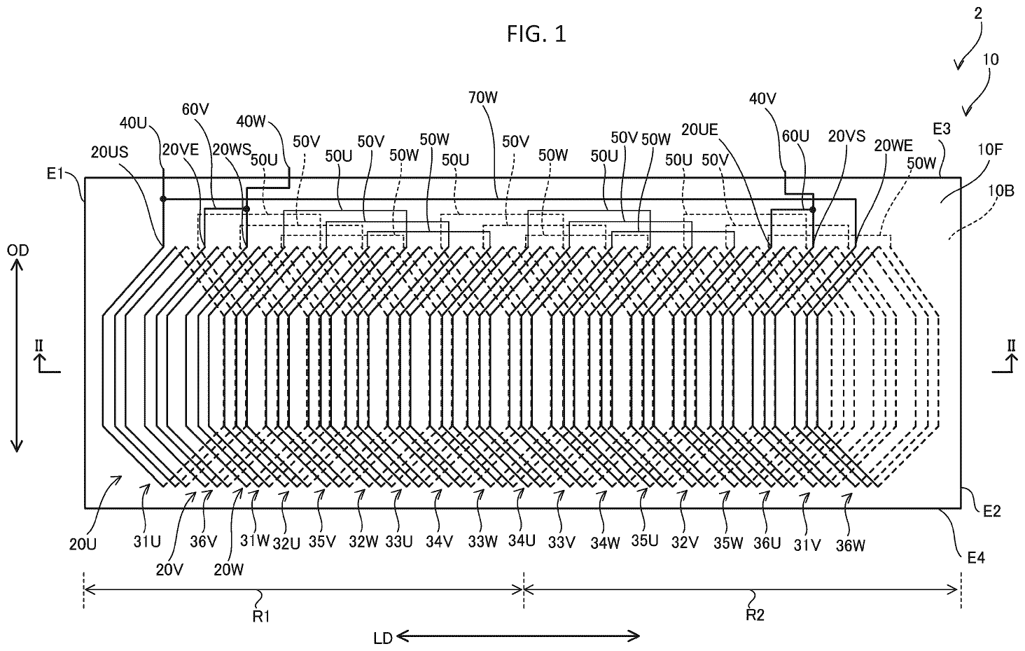

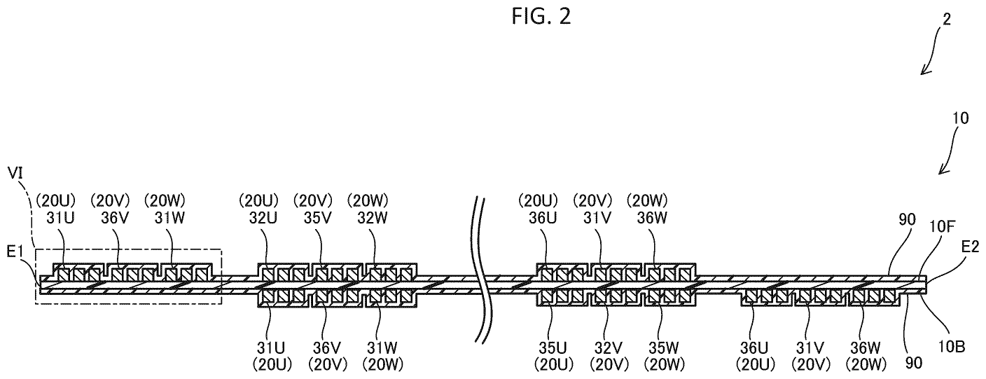

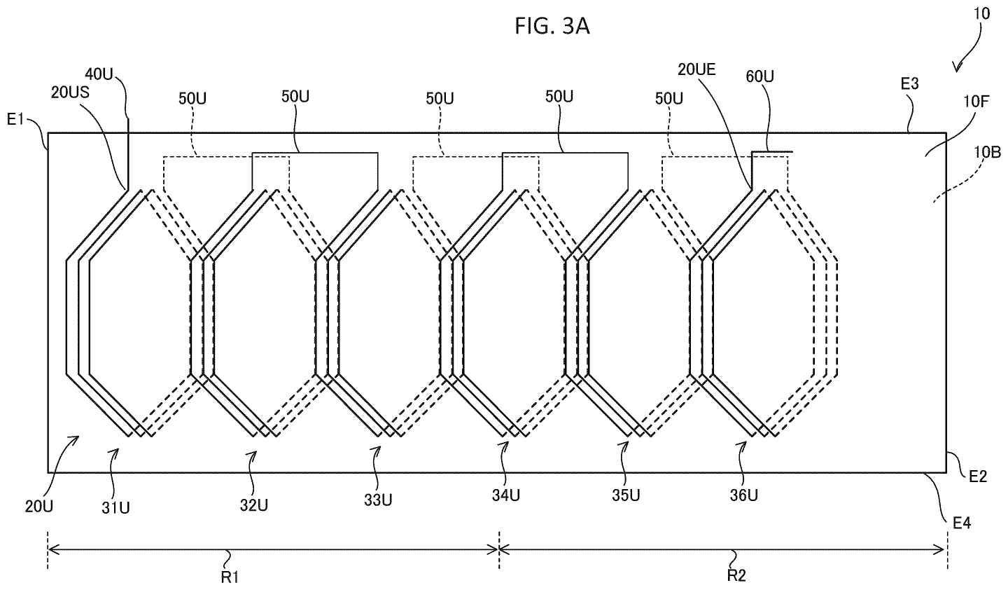

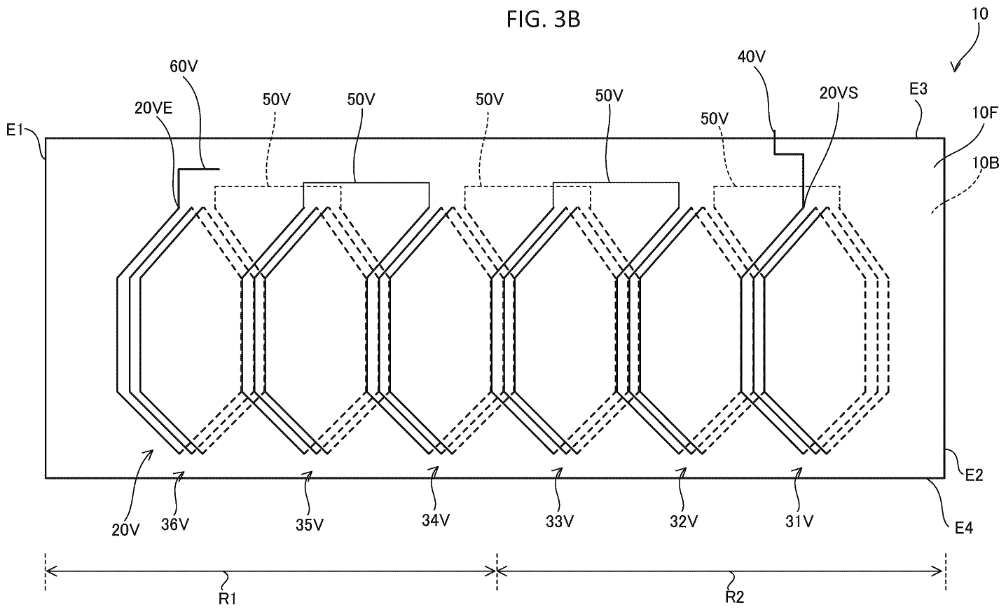

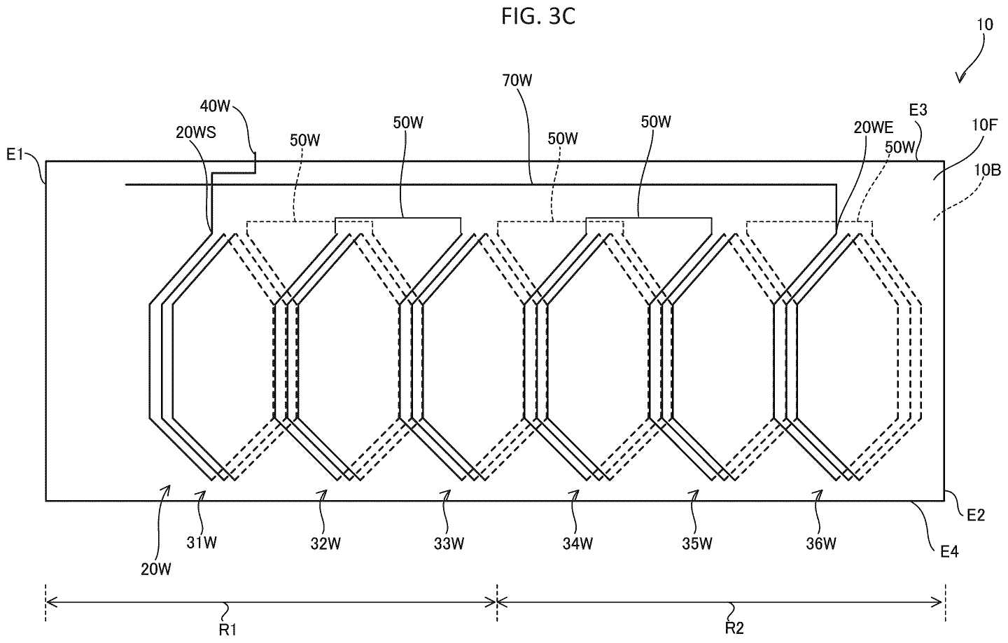

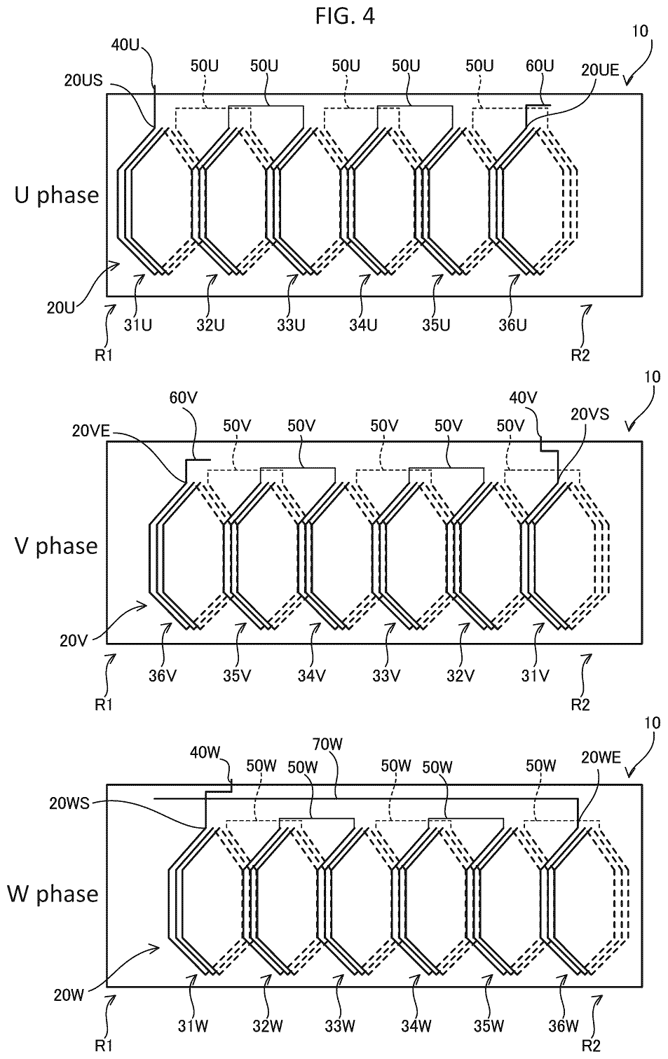

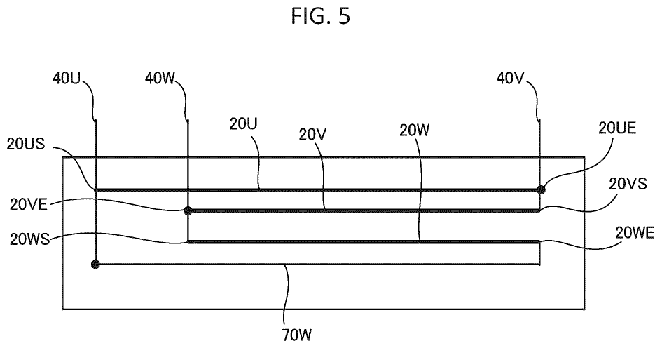

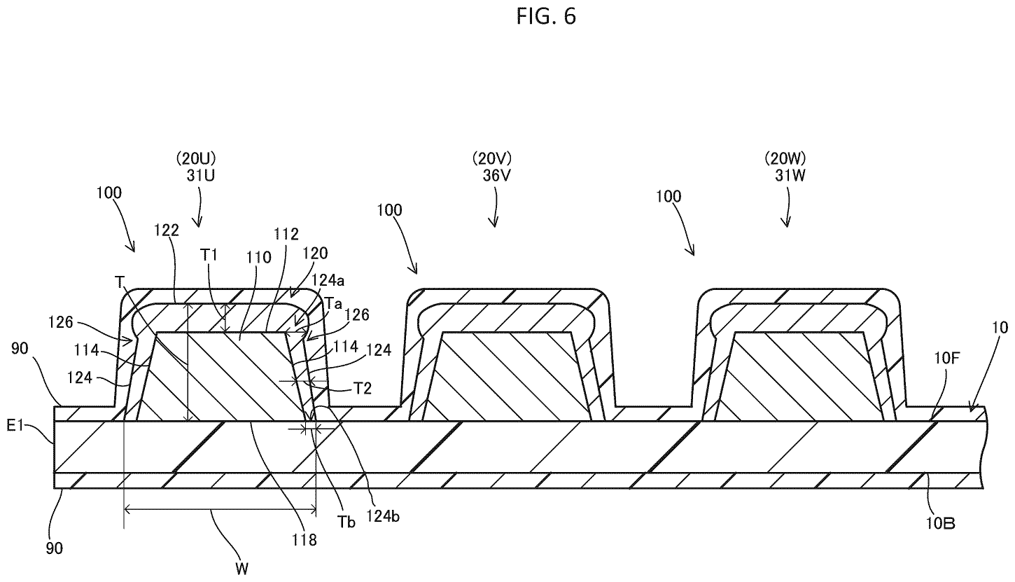

FIG. 1 is a plan view illustrating a coil substrate 2 according to an embodiment of the present invention. FIG. 2 is a cross-sectional view between II-II of FIG. 1. FIGS. 3A-3C are plan views illustrating a U-phase coil (20U), a V-phase coil (20V), and a W-phase coil (20W), respectively. FIG. 4 illustrates plan views comparing the U phase, the V phase, and the W phase of the coil substrate 2 of the embodiment FIG. 5 is a plan view illustrating a simplified version of the coil substrate 2 of FIG. 1. FIG. 6 is an enlarged cross-sectional view of a portion (VI) of FIG. 2.

As illustrated in FIG. 1, the coil substrate 2 has a flexible substrate 10, a U-phase coil (20U), a V-phase coil (20V), a W-phase coil (20W), a U-phase terminal (40U), a V-phase terminal (40V), a W-phase terminal (40W), multiple inter-coil connection wirings (50U, 50V, 50W), multiple interphase connection wirings (60U, 60V), and a return wire (70W).

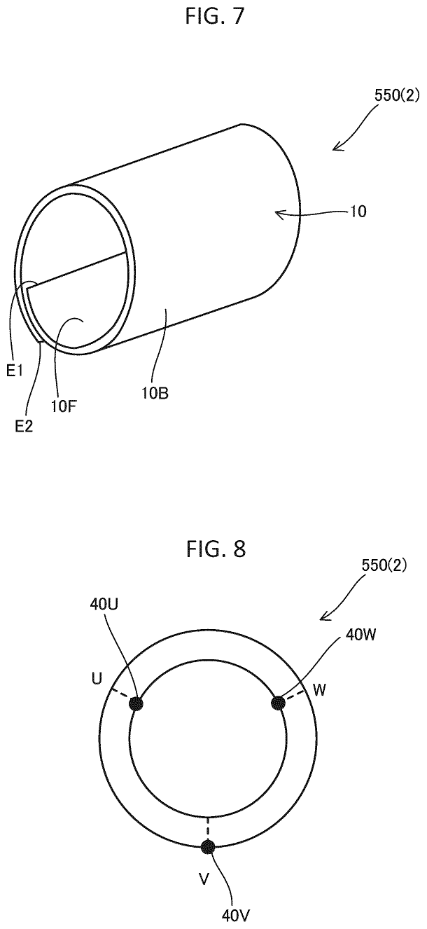

The flexible substrate 10 is a resin substrate having a first surface (10F) and a second surface (10B) on the opposite side with respect to the first surface (10F). The flexible substrate 10 is formed using an insulating resin such as polyimide or polyamide. The flexible substrate 10 is flexible. The flexible substrate 10 is formed in a rectangular shape having four sides, first side (E1)-fourth side (E4). The first side (E1) is a short side on one end side of the flexible substrate 10 in a longitudinal direction (arrow (LD) direction in FIG. 1). The second side (E2) is a short side on the other end side in the longitudinal direction. The first side (E1) and the second side (E2) are short sides extending along an orthogonal direction (arrow (OD) direction in FIG. 1) that is orthogonal to the longitudinal direction. The third side (E3) and the fourth side (E4) are long sides extending in the longitudinal direction. As will be described in detail later, when the coil substrate 2 is wound into a cylindrical shape to form a motor coil substrate 550 (see FIG. 7), the first surface (10F) is positioned on an inner circumferential side and the second surface (10B) is positioned on an outer circumferential side.

The flexible substrate 10 has a first region (R1) on one end side (first side (E1) side) in the longitudinal direction, and a second region (R2) adjacent to the first region (R1). The second region (R2) includes the second side (E2).

The U-phase terminal (40U), the V-phase terminal (40V), and the W-phase terminal (40W) are all formed on the third side (E3) of the flexible substrate 10. In the embodiment, the U-phase terminal (40U) and the W-phase terminal (40W) are formed in the first region (R1). The V-phase terminal (40V) is formed in the second region (R2). As illustrated in FIG. 1, the U-phase terminal (40U) is connected to a starting end (20US) of the U-phase coil (20U). At the same time, the U-phase terminal (40U) is connected to an ending end (20WE) of the W-phase coil (20W) via the return wiring (70W). The V-phase terminal (40V) is connected to a starting end (20VS) of the V-phase coil (20V). At the same time, the V-phase terminal (40V) is connected to an ending end (20UE) of the U-phase coil (20U) via the inter-phase connection wiring (60U). The W-phase terminal (40W) is connected to a starting end (20WS) of the W-phase coil (20W). At the same time, the W-phase terminal (40W) is connected to an ending end (20VE) of the V-phase coil (20V) via the inter-phase connection wiring (60V). That is, in the embodiment, the U-phase coil (20U), the V-phase coil (20V), and the W-phase coil (20W) are A-connected (see FIG. 5). It is also possible that the U-phase coil (20U), the V-phase coil (20V), and the W-phase coil (20W) are connected using a connection method other than the A-connection.

The U-phase coil (20U), the V-phase coil (20V), and the W-phase coil (20W) respectively constitute the U phase, the V phase, and the W phase of a three-phase motor.

As illustrated in FIGS. 1, 3A, and 4, the starting end (20US) of the U-phase coil (20U) is formed in the first region (R1). The ending end (20UE) of the U-phase coil (20U) is formed in the second region (R2). As illustrated in FIG. 3A, the U-phase coil (20U) includes six coils (31U, 32U, 33U, 34U, 35U, 36U). The six coils (31U-36U) are formed in this order from the starting end (20US) to the ending end (20UE) of the U-phase coil (20U) (from the first region (R1) to the second region (R2)). The six coils (31U-36U) are connected to each other by the inter-coil connection wirings (50U).

The six coils (31U-36U) are each formed by forming a wiring constituting a half turn of one turn on the first surface (10F) side, forming a wiring constituting the remaining half turn of the one turn on the second surface (10B) side, and forming adjacent turns in a staggered manner.

Winding start positions (starting ends) of the first coil (31U), the third coil (33U), and the fifth coil (35U) from the starting end (20US) of the U-phase coil (20U) are formed on the first surface (10F), and winding end positions (terminating ends) thereof are formed on the second surface (10B). When the flexible substrate 10 is viewed from the first surface (10F) side, the coils (31U, 33U, 35U) are wound counterclockwise.

On the other hand, winding start positions (starting ends) of the second coil (32U), the fourth coil (34U), and the sixth coil (36U) from the starting end (20US) of the U-phase coil (20U) are formed on the second surface (10B), and winding end positions (terminating ends) thereof are formed on the first surface (10F). When the flexible substrate 10 is viewed from the first surface (10F) side, the coils (32U, 34U, 36U) are wound clockwise.

As illustrated in FIGS. 2, 3A, and 1, a portion of the wiring of the coil (31U) overlaps with a portion of the wiring of the adjacent coil (32U) via the flexible substrate 10. Similarly, a portion of the wiring of the coil (32U) overlaps with a portion of the wiring of the adjacent coil (33U). A portion of the wiring of the coil (33U) overlaps with a portion of the wiring of the adjacent coil (34U). A portion of the wiring of the coil (34U) overlaps with a portion of the wiring of the adjacent coil (35U). A portion of the wiring of the coil (35U) overlaps with a portion of the wiring of the adjacent coil (36U).

As illustrated in FIGS. 3A and 1, the inter-coil connection wiring (50U) connecting the coil (31U) and the coil (32U), the inter-coil connection wiring (50U) connecting the coil (33U) and the coil (34U), and the inter-coil connection wiring (50U) connecting the coil (35U) and the coil (36U) are formed on the second surface (10B). On the other hand, the inter-coil connection wiring (50U) connecting the coil (32U) and the coil (33U) and the inter-coil connection wiring (50U) connecting the coil (34U) and the coil (35U) are formed on the first surface (10F). The U-phase terminal (40U) and the inter-phase connection wiring (60U) are formed on the first surface (10F).

As illustrated in FIGS. 1, 3B, and 4, the starting end (20VS) of the V-phase coil (20V) is formed in the second region (R2). The ending end (20VE) of the V-phase coil (20V) is formed in the first region (R1). As illustrated in FIG. 3B, the V-phase coil (20V) includes six coils (31V, 32V, 33V, 34V, 35V, 36V). The six coils (31V-36V) are formed in this order from the starting end (20VS) to the ending end (20VE) of the V-phase coil (20V) (from the second region (R2) to the first region (R1)). The six coils (31V-36V) are connected to each other by the inter-coil connection wirings (50V).

The six coils (31V-36V) are each formed by forming a wiring constituting a half turn of one turn on the first surface (10F) side, forming a wiring constituting the remaining half turn of the one turn on the second surface (10B) side, and forming adjacent turns in a staggered manner.

Winding start positions (starting ends) of the first coil (31V), the third coil (33V), and the fifth coil (35V) from the starting end (20VS) of the V-phase coil (20V) are formed on the first surface (10F), and winding end positions (terminating ends) thereof are formed on the second surface (10B). When the flexible substrate 10 is viewed from the first surface (10F) side, the coils (31V, 33V, 35V) are wound counterclockwise.

On the other hand, winding start positions (starting ends) of the second coil (32V), the fourth coil (34V), and the sixth coil (36V) from the starting end (20VS) of the V-phase coil (20V) are formed on the second surface (10B), and winding end positions (terminating ends) thereof are formed on the first surface (10F). When the flexible substrate 10 is viewed from the first surface (10F) side, the coils (32V, 34V, 36V) are wound clockwise.

As illustrated in FIGS. 2, 3B, and 1, a portion of the wiring of the coil (31V) overlaps with a portion of the wiring of the adjacent coil (32V) via the flexible substrate 10. Similarly, a portion of the wiring of the coil (32V) overlaps with a portion of the wiring of the adjacent coil (33V). A portion of the wiring of the coil (33V) overlaps with a portion of the wiring of the adjacent coil (34V). A portion of the wiring of the coil (34V) overlaps with a portion of the wiring of the adjacent coil (35V). A portion of the wiring of the coil (35V) overlaps with a portion of the wiring of the adjacent coil (36V).

As illustrated in FIGS. 3B and 1, the inter-coil connection wiring (50V) connecting the coil (31V) and the coil (32V), the inter-coil connection wiring (50V) connecting the coil (33V) and the coil (34V), and the inter-coil connection wiring (50V) connecting the coil (35V) and the coil (36V) are formed on the second surface (10B). On the other hand, the inter-coil connection wiring (50V) connecting the coil (32V) and the coil (33V) and the inter-coil connection wiring (50V) connecting the coil (34V) and the coil (35V) are formed on the first surface (10F). The V-phase terminal (40V) and the inter-phase connection wiring (60V) are formed on the first surface (10F).

As illustrated in FIGS. 1, 3C, and 4, the starting end (20WS) of the W-phase coil (20W) is formed in the first region (R1). The ending end (20WE) of the W-phase coil (20W) is formed in the second region (R2). As illustrated in FIG. 3C, the W-phase coil (20W) includes six coils (31W, 32W, 33W, 34W, 35W, 36W). The six coils (31W-36W) are formed in this order from the starting end (20WS) to the ending end (20WE) of the W-phase coil (20W) (from the first region (R1) to the second region (R2)). The six coils (31W-36W) are connected to each other by the inter-coil connection wirings (50W).

The six coils (31W-36W) are each formed by forming a wiring constituting a half turn of one turn on the first surface (10F) side, forming a wiring constituting the remaining half turn of the one turn on the second surface (10B) side, and forming adjacent turns in a staggered manner.

Winding start positions (starting ends) of the first coil (31W), the third coil (33W), and the fifth coil (35W) from the starting end (20WS) of the W-phase coil (20W) are formed on the first surface (10F), and winding end positions (terminating ends) thereof are formed on the second surface (10B). When the flexible substrate 10 is viewed from the first surface (10F) side, the coils (31W, 33W, 35W) are wound counterclockwise.

On the other hand, winding start positions (starting ends) of the second coil (32W), the fourth coil (34W), and the sixth coil (36W) from the starting end (20WS) of the W-phase coil (20W) are formed on the second surface (10B), and winding end positions (terminating ends) thereof are formed on the first surface (10F). When the flexible substrate 10 is viewed from the first surface (10F) side, the coils (32W, 34W, 36W) are wound clockwise.

As illustrated in FIGS. 2, 3C, and 1, a portion of the wiring of the coil (31W) overlaps with a portion of the wiring of the adjacent coil (32W) via the flexible substrate 10. Similarly, a portion of the wiring of the coil (32W) overlaps with a portion of the wiring of the adjacent coil (33W). A portion of the wiring of the coil (33W) overlaps with a portion of the wiring of the adjacent coil (34W). A portion of the wiring of the coil (34W) overlaps with a portion of the wiring of the adjacent coil (35W). A portion of the wiring of the coil (35W) overlaps with a portion of the wiring of the adjacent coil (36W).

As illustrated in FIGS. 3C and 1, the inter-coil connection wiring (50W) connecting the coil (31W) and the coil (32W), the inter-coil connection wiring (50W) connecting the coil (33W) and the coil (34W), and the inter-coil connection wiring (50W) connecting the coil (35W) and the coil (36W) are formed on the second surface (10B). On the other hand, the inter-coil connection wiring (50W) connecting the coil (32W) and the coil (33W) and the inter-coil connection wiring (50W) connecting the coil (34W) and the coil (35W) are formed on the first surface (10F). The W-phase terminal (40W) and the return wiring (70W) are formed on the first surface (10F).

As illustrate in FIGS. 3C, 5, and 1, the return wiring (70W) connects between the ending end (20WE) of the W-phase coil (20W) and the U-phase terminal (40U). The return wiring (70W) extends from the second region (R2) to the first region (R1).

As illustrated in FIG. 2, the first surface (10F), and the wirings of the coils (20U, 20V, 20W), the inter-coil connection wirings (50U, 50V, 50W), the inter-phase connection wirings (60U, 60V), and the return wiring (70W), which are formed on the first surface (10F), are covered by a resin insulation layer 90. Similarly, the second surface (10B), and the wirings of the coils (20U, 20V, 20W) and the inter-coil connection wirings (50U, 50V, 50W), which are formed on the second surface (10B), are covered by a resin insulation layer 90. A thickness of each of the resin insulating layers 90 is not particularly limited, but it is, as an example, about 10 μm to 20 μm. In FIGS. 1, 3A-3C, 4, and 5, the resin insulating layers 90 are omitted.

FIG. 6 is an enlarged cross-sectional view of a portion (VI) of FIG. 2. Wirings 100 forming the coils (20U, 20V, 20W) (in FIG. 6, the coils (31U, 36V, 31W)) each have a first layer 110 formed on the first surface (10F) of the flexible substrate 10 and a second layer 120 covering an outer surface of the first layer 110. The first layer 110 and the second layer 120 are formed of a metal containing copper. In FIG. 6, only the wirings 100 included in the portion (VI) of FIG. 2 are illustrated. However, the other wirings in FIG. 2 are similar to the wirings 100 of FIG. 6.

The first surface (10F) of the flexible substrate 10 and surfaces of the wirings 100 on the first surface (10F) are covered with the resin insulating layer 90. Similarly, the second surface (10B) of the flexible substrate 10 and surfaces of the wirings 100 on the second surface (10B) are covered with the resin insulating layer 90. As illustrated in FIG. 6, the resin insulating layer 90 is formed along a shape of the wirings 100. The resin insulating layer 90 in FIG. 6 is an example of a formation mode, and it is also possible that the resin insulating layer 90 is formed to have a substantially flush surface by filling spaces between adjacent wirings 100.

The first layer 110 is formed by etching a copper foil or a conductor containing a copper foil formed on the first surface (10F) and the second surface (10B) of the flexible substrate 10. The second layer 120 is formed by electrolytic plating (additional plating) with copper as a main component after the formation of the first layer 110. In FIG. 6, the first layer 110 is a single layer. However, it is also possible that the first layer 110 is formed as a multilayer structure with two or more layers. Similarly, in FIG. 6, the second layer 120 is a single layer. However, it is also possible that the second layer 120 is formed as a multilayer structure with two or more layers.

The wirings 100 each have a width (W) of 60 μm or more and 400 μm or less. The wirings 100 each have a thickness (T) of 20 μm or more and 200 μm or less. The second layer 120 has a first portion 122 that covers an upper surface 112 of the first layer 110, and a second portion 124 that covers a side surface 114 of the first layer 110. The first portion 122 of the second layer 120 has a thickness (T1), and the second portion 124 of the second layer 120 has a thickness (T2). The thickness (T1) of the first portion 122 of the second layer 120 is not particularly limited, but may be 10 μm or more and 80 μm or less. Further, the thickness (T1) of the first portion 122 may be constant, or the thickness (T1) of the first portion 122 may be non-constant. The thickness (T2) of the second portion 124 of the second layer 120 is not particularly limited, but may be 7 μm or more and 60 μm or less. The thickness (T2) of the second portion 124 may be constant, or the thickness (T2) of the second portion 124 may gradually decrease toward the flexible substrate 10. A gradual decrease ratio of the thickness (T2) of the second portion 124 is 1% or more and 20% or less. The gradual decrease ratio is a ratio of a thinner portion to a thicker portion in the thickness (T2). A recess 126 is formed in a portion of the second portion 124 close to the first portion 122. The thickness of the second layer 120 at the recess 126 is smaller than that of other portions of the first portion 122. The recess 126 is formed due to a difference in growth rate of the plating layer between the upper surface 112 and the side surface 114 of the first layer 110 during the additional plating. A part of the resin insulating layer 90 extends into the recess 126. Since the wirings 100 have the recess 126, adhesion between the wirings 100 and the resin insulating layer 90 covering the wirings 100 is high. The resin insulating layer 90 is unlikely to peel off.

The thickness (T1) of the first portion 122 of the second layer 120 is greater than the thickness (T2) of the second portion 124 of the second layer 120. Short-circuiting between adjacent wirings 100 is unlikely to occur. Electrical connectivity is improved. Further, a space factor of the wirings 100 can be increased. Further, a ratio (T1/T2) of the thickness (T1) of the first portion 122 to the thickness (T2) of the second portion 124 is greater than 1.0 and less than or equal to 1.4. When the ratio of the thickness (T1) to the thickness (T2) is greater than 1.0 and less than or equal to 1.4, short-circuiting between adjacent wirings 100 is unlikely to occur. Electrical connectivity is improved. Further, a space factor of the wirings 100 can be increased. The coil substrate when wound has a desired shape. In other words, the first portion 122 of the second layer 120 has the thickness (T1), the second portion 124 of the second layer 120 has the thickness (T2), and the ratio (T1/T2) of the thickness (T1) of the first portion 122 to the thickness (T2) of the second portion 124 satisfies the following relational expression 1:

$$0.1 < T 1 / T 2 ≦ 1.4 \qquad Expression 1$$

Therefore, performance of the coil substrate 2 as a motor coil substrate is high. When the coil substrate 2 is used in a motor, performance of the motor, such as torque, is improved. When the ratio of the thickness (T1) to the thickness (T2) is less than 1.0, there is a high risk that short-circuiting between adjacent wirings 100 may occur. When the ratio of the thickness (T1) to the thickness (T2) is greater than 1.4, gaps between the wirings 100 become wider, and as a result, the space factor of the wirings 100 cannot be increased.

The second portion 124 includes an upper end vicinity portion (124a) located on an extension line of the upper surface 112 of the first layer 110 and a lower end vicinity portion (124b) located on an extension line of a lower surface 118 of the first layer 110. A thickness (Ta) of the upper end vicinity portion (124a) is greater than a thickness (Tb) of the lower end vicinity portion (124b). The difference between the thickness (Ta) and the thickness (Tb) occurs because plating solution has difficulty penetrating near the lower surface 118 during the electroplating (additional plating). Since the thickness (Ta) of the upper end vicinity portion (124a) is greater than the thickness (Tb) of the lower end vicinity portion (124b), short-circuiting near the second portion 124 between adjacent wirings 100 is suppressed.

It is desirable that the width (W) of each of the wirings 100 is 100 μm or more and 300 μm or less. It is desirable that the thickness (T) of each of the wirings 100 is 40 μm or more and 100 μm or less. Further, it is desirable that the width (W) of each of the wirings 100 is 100 μm or more and 300 μm or less, and the thickness (T) of each of the wirings 100 is 20 μm or more and 200 μm or less. It is desirable that the width (W) of each of the wirings 100 is 60 μm or more and 400 μm or less, and the thickness (T) of each of the wirings 100 is 40 μm or more and 100 μm or less. Further, it is desirable that the width (W) of each of the wirings 100 is 100 μm or more and 300 μm or less, and the thickness (T) of each of the wirings 100 is 40 μm or more and 100 μm or less. When the width (W) of each of the wirings 100 is 100 μm or more and 300 μm or less, or when the thickness (T) of each of the wirings 100 is 40 μm or more and 100 μm or less, influence of eddy current loss and wiring resistance in the coil substrate are suppressed. When the width (W) is 300 μm or less, eddy current can be reduced. When the width (W) is 100 μm or more, resistance of the wirings 100 can be reduced. When the thickness (T) is 40 μm or more, the resistance of the wirings 100 can be reduced. When the thickness (T) is 100 μm or less, the eddy current can be reduced. Further, when the thickness (T) is 100 μm or less, roundness of the coil substrate 2 when wound into a cylindrical shape is high. In one example, the width (W) is 300 μm and the thickness (T) is 90 μm. In this example, the width (W) and the thickness (T) of each wiring 100 are measured based on an SEM image (×200). The width (W) is a measured value at a longest part of the wiring.

In the embodiment, for each of the wirings 100, the width (W) is 350 μm and the thickness (T) is 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

FIG. 7 is a perspective view schematically illustrating a motor coil substrate 550 formed using the coil substrate 2 of the embodiment (FIGS. 1 to 5). As illustrated in FIG. 7, the motor coil substrate 550 for a motor is formed by winding the coil substrate 2 of the embodiment (FIGS. 1-5) into a cylindrical shape. When the coil substrate 2 is wound into a cylindrical shape, the coil substrate 2 is wound multiple turns around an axis extending in the orthogonal direction (an axis extending parallel to the first side (E1)) with the first side (E1) (FIG. 1) as a starting point. The number of turns of the coil substrate 2 is not particularly limited, but is desirably 4 to 10. When the coil substrate 2 is wound into a cylindrical shape, the first surface (10F) of the flexible substrate 10 is positioned on the inner circumferential side, and the second surface (10B) is positioned on the outer circumferential side. When the coil substrate 2 is wound into a cylindrical shape, it is also possible that the first surface (10F) of the flexible substrate 10 is positioned on the outer circumferential side, and the second surface (10B) is positioned on the inner circumferential side. A winding method is determined by specifications of the coil substrate 2, or designs for wiring widths, wiring thicknesses, and the like.

FIG. 8 schematically illustrates positions of the terminals when the motor coil substrate 550 is viewed along an axial direction. As illustrated in FIG. 8, the U-phase terminal (40U), the V-phase terminal (40V), and the W-phase terminal (40W) are formed at substantially 120-degree intervals in a circumferential direction. The U-phase terminal (40U) and the W-phase terminal (40W) are formed on an inner circumferential surface. The V-phase terminal (40V) is formed on an outer circumferential surface. The positioning of the U-phase terminal (40U), the V-phase terminal (40V), and the W-phase terminal (40W) may be other than the positioning illustrated in FIG. 8.

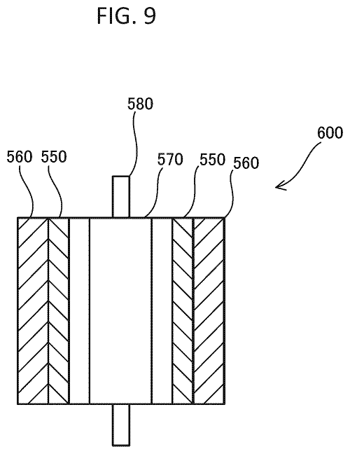

FIG. 9 is a cross-sectional view schematically illustrating a motor 600 formed using the motor coil substrate 550 of the embodiment (FIGS. 7 and 8). The motor 600 is formed by positioning the motor coil substrate 550 on an inner side of a yoke 560, and positioning a rotation shaft 580 and a magnet 570 fixed to the rotation shaft 580 on an inner side of the motor coil substrate 550.

In the above, the structures of the coil substrate 2 (FIGS. 1-6), the motor coil substrate 550 (FIGS. 7 and 8), and the motor 600 (FIG. 9) of the embodiment have been described. As described above, in the coil substrate 2 of the embodiment, the width (W) of each of the wirings 100 is 60 μm or more and 400 μm or less, and the thickness (T) of each of the wirings 100 is 20 μm or more and 200 μm or less (FIG. 6). Therefore, influence of eddy current loss and wiring resistance is suppressed. The eddy current loss is lower than when the wiring width is greater than 400 μm. The eddy current loss is lower than when the wiring thickness is greater than 200 μm. The wiring resistance is lower than when the wiring width is less than 60 μm. The wiring resistance is lower than when the wiring thickness is less than 20 μm. When the coil substrate 2 of the embodiment is used in the motor 600, a high-performance motor 600 is obtained.

In the coil substrate 2 of the embodiment, the ratio (T1/T2) of the thickness (T1) of the first portion 122 of the second layer 120 to the thickness (T2) of the second portion 124 of the second layer 120 is greater than 1.0 and less than or equal to 1.4. When the ratio of the thickness (T1) to the thickness (T2) is greater than 1.0 and less than or equal to 1.4, short-circuiting between adjacent wirings 100 is unlikely to occur. Electrical connectivity is improved. Further, a space factor of the wirings 100 can be increased. Therefore, in the coil substrate 2 of the embodiment, multiple wirings 100 can be formed at high density. When the coil substrate 2 of the embodiment is used for the motor 600, a small motor 600 can be obtained. Further, a high-performance motor 600 can be obtained.

In the coil substrate 2 of the embodiment, the U-phase terminal (40U) and the W-phase terminal (40W) are formed in the first region (R1), and the V-phase terminal (40V) is formed in the second region (R2). Therefore, the return wiring (70W) is the only inter-phase connection wiring extending across the first region (R1) and the second region (R2), and the other inter-phase connection wirings (60U, 60V) are shorter than the return wiring (70W). The inter-phase connection wirings (60U, 60V) can be shortened. Therefore, resistance can be reduced when the coil substrate 2 is used as the motor coil substrate 550. When the motor 600 is formed using the motor coil substrate 550 of the embodiment, a motor 600 with stable performance can be obtained.

### First Modified Example

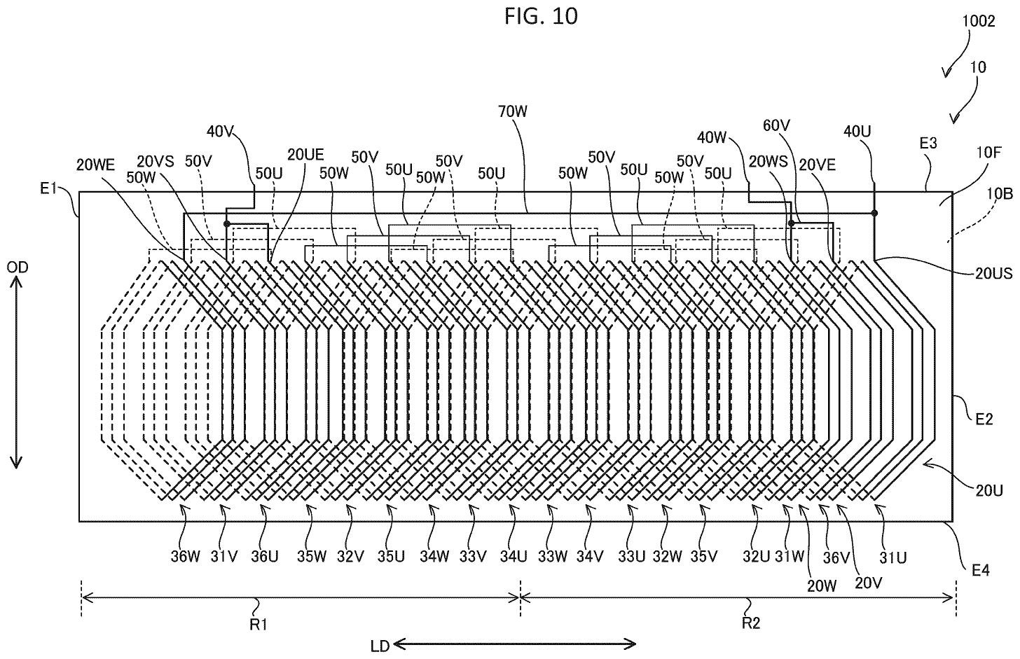

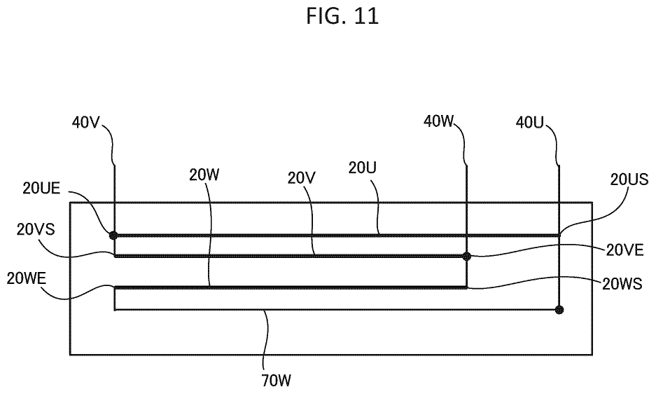

FIGS. 10 and 11 illustrate a first modified example of the embodiment. FIG. 10 is a plan view illustrating a coil substrate 1002 of the first modified example. FIG. 11 is a plan view illustrating a simplified version of the coil substrate 1002 of FIG. 10. In the first modified example, the positions of the U-phase terminal (40U), the V-phase terminal (40V), and the W-phase terminal (40W) are opposite to those in the embodiment. That is, the V-phase terminal (40V) is formed in the first region (R1), and the U-phase terminal (40U) and the W-phase terminal (40W) are formed in the second region (R2).

The starting end (20US) of the U-phase coil (20U) is formed in the second region (R2). The ending end (20UE) of the U-phase coil (20U) is formed in the first region (R1). The six coils (31U-36U) are formed in this order from the starting end (20US) to the ending end (20UE) of the U-phase coil (20U) (from the second region (R2) to the first region (R1)). The coils (31U, 33U, 35U) are wound clockwise. The coils (32U, 34U, 36U) are wound counterclockwise.

The starting end (20VS) of the V-phase coil (20V) is formed in the first region (R1). The ending end (20VE) of the V-phase coil (20V) is formed in the second region (R2). The six coils (31V-36V) are formed in this order from the starting end (20VS) to the ending end (20VE) of the V-phase coil (20V) (from the first region (R1) to the second region (R2)). The coils (31V, 33V, 35V) are wound clockwise. The coils (32V, 34V, 36V) are wound counterclockwise.

The starting end (20WS) of the W-phase coil (20W) is formed in the second region (R2). The ending end (20WE) of the W-phase coil (20W) is formed in the first region (R1). The six coils (31W-36W) are formed in this order from the starting end (20WS) to the ending end (20WE) of the W-phase coil (20W) (from the second region (R2) to the first region (R1)). The coils (31W, 33W, 35W) are wound clockwise. The coils (32W, 34W, 36W) are wound counterclockwise.

In the first modified example, the wirings 100 each have a width (W) (see FIG. 6) of 350 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

As illustrate in FIGS. 10 and 11, the return wiring (70W) connects between the ending end (20WE) of the W-phase coil (20W) and the U-phase terminal (40U). The return wiring (70W) extends from the first region (R1) to the second region (R2).

As described above, in the coil substrate 1002 of the first modified example, the V-phase terminal (40V) is formed in the first region (R1), and the U-phase terminal (40U) and the W-phase terminal (40W) are formed in the second region (R2). Therefore, the return wiring (70W) is the only inter-phase connection wiring extending across the first region (R1) and the second region (R2), and the other inter-phase connection wirings (60U, 60V) are shorter than the return wiring (70W). The inter-phase connection wirings (60U, 60V) can be shortened. Therefore, resistance can be reduced when the coil substrate 1002 is used as the motor coil substrate 550. When the motor 600 is formed using the motor coil substrate 550 of the first modified example, a motor 600 with stable performance can be obtained.

### Second Modified Example

Although illustration is omitted, in a second modified example, the positioning of the wirings constituting the coils (31U-36U, 31V-36V, 31W-36W) differs from that in the embodiment. In the second modified example as well, the coils each formed of a coil-shaped wiring (first wiring) provided on the first surface (10F) and a coil-shaped wiring (second wiring) provided on the second surface (10B). The first wiring and the second wiring are electrically connected via a via conductor that penetrates the flexible substrate 10. The first wiring is formed in a spiral shape (hexagonal spiral shape) from an outer circumference toward an inner circumference. The via conductor is formed at an inner circumference side end of the first wiring. On the other hand, the second wiring is formed in a spiral (hexagonal spiral) shape from the inner circumference toward the outer circumference. The first wiring and the second wiring are formed in spiral shapes wound in the same direction when viewed from the first surface (10F). The first wiring and the second wiring are electrically connected in series and function as one coil.

In the second modified example, the wirings 100 each have a width (W) (see FIG. 6) of 350 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

### Third Modified Example

Although illustration is omitted, in a third modified example, the positioning of the wirings constituting the coils (31U-36U, 31V-36V, 31W-36W) differs from that in the embodiment. In the third modified example, the wirings constituting the coils are provided on either the first surface (10F) or the second surface (10B).

In the third modified example, the wirings 100 each have a width (W) (see FIG. 6) of 350 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

### Fourth Modified Example

A structure of a coil substrate of a fourth modified example is the same as that in the embodiment. In the fourth modified example, the wirings 100 each have a width (W) of 250 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

### Fifth Modified Example

A structure of a coil substrate of a fifth modified example is the same as that in the first modified example. In the fifth modified example, the wirings 100 each have a width (W) of 250 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

### Sixth Modified Example

A structure of a coil substrate of a sixth modified example is the same as that in the second modified example. In the sixth modified example, the wirings 100 each have a width (W) of 250 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

### Seventh Modified Example

A structure of a coil substrate of a seventh modified example is the same as that in the third modified example. In the seventh modified example, the wirings 100 each have a width (W) of 250 μm and a thickness (T) of 56 μm. The thickness (T1) of the first portion 122 of the second layer 120 is 22 μm. The thickness (T2) of the second portion 124 of the second layer 120 is 18 μm. The ratio (T1/T2) of the thickness (T1) to the thickness (T2) is 1.2.

Japanese Patent Application Laid-Open Publication No. Sho 57-186941 describes a motor coil having a substrate and a coil conductor formed on the substrate. The coil conductor is formed by etching a copper foil to form a pattern and then performing additional electroplating. It is described that the coil conductor (coil wiring) has a width of 0.485 mm (485 μm). Further, International Publication No. 2018/211733 describes a printed wiring board having a base film and a conductive pattern including multiple wiring parts formed on the base film. The wiring parts each have a first conductive part and a second conductive part covering an outer surface of the first conductive part. It is described that the wiring parts (coil wirings) have an average width of 10 μm or more and 50 μm or less.

The coil conductor (coil wiring) of Japanese Patent Application Laid-Open Publication No. Sho 57-186941 has a large width, resulting in high eddy current loss. The wiring parts (coil wirings) of International Publication No. 2018/211733 have a small width, resulting in high wiring resistance. Therefore, it is thought that even when the motor coil of Japanese Patent Application Laid-Open Publication No. Sho 57-186941 or the printed wiring board of International Publication No. 2018/211733 is used in a motor, a high-performance motor cannot be obtained.

A coil substrate according to an embodiment of the present invention includes: a flexible substrate having a first surface and a second surface on the opposite side with respect to the first surface; a coil formed by a wiring provided on at least one of the first surface and the second surface; and a resin insulating layer covering the wiring. The wiring has a first layer and a second layer covering an outer surface of the first layer. The second layer has a first portion that covers an upper surface of the first layer and a second portion that covers a side surface of the first layer. The wiring has a width of 60 μm or more and 400 μm or less. The first portion of the second layer has a thickness (T1), the second portion of the second layer has a thickness (T2), and a ratio (T1/T2) of the thickness (T1) of the first portion to the thickness (T2) of the second portion satisfies the following relational expression 1:

$$1. < T 1 / T 2 ≦ 1.4 \qquad Expression 1$$

In the coil substrate, the wiring has a width of 60 μm or more and 400 μm or less, and the ratio of the thickness of the first portion of the second layer to the thickness of the second portion of the second layer is greater than 1.0 and less than or equal to 1.4. The first portion is thicker than the second portion. Therefore, influence of eddy current loss and wiring resistance is suppressed. The first portion of the second layer has a thickness (T1), the second portion of the second layer has a thickness (T2), and the ratio (T1/T2) of the thickness (T1) of the first portion to the thickness (T2) of the second portion satisfies the following relational expression 1:

$$1. < T 1 / T 2 ≦ 1.4 \qquad Expression 1$$

Therefore, short-circuiting between adjacent wirings is unlikely to occur. Electrical connectivity is improved. Specifically, the eddy current loss is lower than when the wiring width is greater than 400 μm. The wiring resistance is lower than when the wiring width is less than 60 μm. When the coil substrate is used for a motor, a small motor can be obtained. Further, a high performance motor can be obtained. In the coil substrate, the wiring may have a thickness of 20 μm or more and 200um or less.

In the coil substrate, a recess may be formed in the second portion. In the coil substrate, the second portion may have an upper end vicinity portion located on an extension line of the upper surface and a lower end vicinity portion located on an extension line of a lower surface of the first layer. A thickness of the upper end vicinity portion is greater than a thickness of the lower end vicinity portion. In the coil substrate, the wiring may have a width of 100 μm or more and 300 μm or less.

In the coil substrate, the wiring may have a thickness of 40 μm or more and 100 μm or less.

In the coil substrate, the wiring may have a width of 100 μm or more and 300 μm or less, and a thickness of 20 μm or more and 200 μm or less.

In the coil substrate, the wiring may have a width of 60 μm or more and 400 μm or less, and a thickness of 40 μm or more and 100 μm or less.

In the coil substrate, the wiring may have a width of 100 μm or more and 300 μm or less, and a thickness of 40 μm or more and 100 μm or less.

In the coil substrate, the second portion of the second layer may have a thickness that decreases toward the flexible substrate.

A motor coil substrate according to an embodiment of the present invention is formed by winding a coil substrate according to an embodiment of the present invention into a cylindrical shape.

In the motor coil substrate, the wiring has a width of 60 μm or more and 400 μm or less, and the ratio of the thickness of the first portion of the second layer to the thickness of the second portion of the second layer is greater than 1.0 and less than or equal to 1.4. The first portion is thicker than the second portion. Therefore, influence of eddy current loss and wiring resistance is suppressed. When the ratio of the thickness of the first portion of the second layer to the thickness of the second portion of the second layer is greater than 1.0 and less than or equal to 1.4, short-circuiting between adjacent wirings is unlikely to occur. Electrical connectivity is improved. Specifically, the eddy current loss is lower than when the wiring width is greater than 400 μm. The wiring resistance is lower than when the wiring width is less than 60 μm. When the motor coil substrate is used for a motor, a small motor can be obtained. Further, a high performance motor can be obtained.

A motor according to an embodiment of the present invention is formed by positioning a motor coil substrate according to an embodiment of the present invention on an inner side of a cylindrical yoke, and positioning a rotation shaft and a magnet on an inner side of the motor coil substrate.

In the motor, eddy current loss and wiring resistance are small. Multiple wirings can be formed at high density. A motor with stable performance can be obtained.

Obviously, numerous modifications and variations of the present invention are possible in light of the above teachings. It is therefore to be understood that within the scope of the appended claims, the invention may be practiced otherwise than as specifically described herein.

1. A coil substrate, comprising:
a flexible substrate having a first surface and a second surface on an opposite side with respect to the first surface;
a coil comprising a wiring and formed on at least one of the first surface and second surface of the flexible substrate; and
a resin insulating layer covering the wiring of the coil formed on the at least one of the first surface and second surface of the flexible substrate,
wherein the coil is formed such that the wiring has a first layer and a second layer covering an outer surface of the first layer and that the second layer has a first portion covering an upper surface of the first layer and a second portion covering a side surface of the first layer, and the wiring of the coil is formed such that the wiring has a width in a range of 60 μm to 400 μm and that a ratio T1/T2 of a thickness T1 of the first portion to a thickness T2 of the second portion satisfies 1.0<T1/T2≤1.4.

2. The coil substrate according to claim 1, wherein the coil is formed such that the wiring has a thickness in a range of 20 μm to 200 μm.

3. The coil substrate according to claim 1, wherein the coil is formed such that a recess is formed in the second portion of the second layer.

4. The coil substrate according to claim 1, wherein the coil is formed such that the second portion of the second layer has an upper end vicinity portion formed on an extension line of the upper surface and a lower end vicinity portion formed on an extension line of a lower surface of the first layer and that a thickness of the upper end vicinity portion is greater than a thickness of the lower end vicinity portion.

5. The coil substrate according to claim 1, wherein the coil is formed such that the wiring has a width in a range of 100 μm to 300 μm.

6. The coil substrate according to claim 1, wherein the coil is formed such that the wiring has a thickness in a range of 40 μm to 100 μm.

7. The coil substrate according to claim 1, wherein the coil is formed such that the wiring has a width in a range of 100 μm to 300 μm and a thickness in a range of 20 μm to 200 μm.

8. The coil substrate according to claim 1, wherein the coil is formed such that the wiring has a width in a range of 100 μm to 300 μm and a thickness in a range of 40 μm to 100 μm.

9. The coil substrate according to claim 1, wherein the coil is formed such that the second portion of the second layer has a thickness that decreases toward the flexible substrate.

10. The coil substrate according to claim 2, wherein the coil is formed such that a recess is formed in the second portion of the second layer.

11. The coil substrate according to claim 2, wherein the coil is formed such that the second portion of the second layer has an upper end vicinity portion formed on an extension line of the upper surface and a lower end vicinity portion formed on an extension line of a lower surface of the first layer and that a thickness of the upper end vicinity portion is greater than a thickness of the lower end vicinity portion.

12. The coil substrate according to claim 2, wherein the coil is formed such that the second portion of the second layer has a thickness that decreases toward the flexible substrate.

13. The coil substrate according to claim 3, wherein the coil is formed such that the second portion of the second layer has an upper end vicinity portion formed on an extension line of the upper surface and a lower end vicinity portion formed on an extension line of a lower surface of the first layer and that a thickness of the upper end vicinity portion is greater than a thickness of the lower end vicinity portion.

14. The coil substrate according to claim 3, wherein the coil is formed such that the wiring has a width in a range of 100 μm to 300 μm.

15. The coil substrate according to claim 3, wherein the coil is formed such that the wiring has a thickness in a range of 40 μm to 100 μm.

16. The coil substrate according to claim 3, wherein the coil is formed such that the wiring has a width in a range of 100 μm to 300 μm and a thickness in a range of 20 μm to 200 μm.

17. The coil substrate according to claim 3, wherein the coil is formed such that the wiring has a width in a range of 100 μm to 300 μm and a thickness in a range of 40 μm to 100 μm.

18. The coil substrate according to claim 3, wherein the coil is formed such that the second portion of the second layer has a thickness that decreases toward the flexible substrate.

19. A motor coil substrate, comprising:
the coil substrate of claim 1 wound into a cylindrical shape.

20. A motor, comprising:
a cylindrical yoke;
the motor coil substrate of claim 19 formed on an inner side of the cylindrical yoke;
a magnet positioned on the inner side of the cylindrical yoke such that the magnet is positioned on an inner side of the motor coil substrate; and
a rotation shaft positioned on the inner side of the cylindrical yoke such that the rotational shaft is positioned in the magnet.
